(19) United States
(12) Patent Application Publication
(10) Pub. No.: US 2002/0178768 A1
(43) Pub. Date: Dec. 5, 2002

(54) Rolling chock in tilting bar lock

(76) Inventor: Heitor Curra, Cunha-Rio Grande (BR)

Correspondence Address: Oppenheimer Wolff & Donnelly, Suite 3800, 2029 Century Park East, Los Angeles, CA, 90067, US

(21) Appl. No.: 10/089,636

(22) PCT Filed: Apr. 8, 2001
(86) PCT No.: PCT/BR01/00039

(30) Foreign Application Priority Data
Jul. 31, 2000 (BR) PI 0003637.4

(51) Int. Cl. E05B 59/00; E05B 63/14

(52) U.S. Cl. 70/107

(57) ABSTRACT

Technical sector is that of metallurgy. Characterized by a Rolling Wedge over an inclined Tilting Bar, locking the return of the Counterpart with Groove installed in the doorframe, with the option of installing hinges so that the door can open to both sides with the installation of pairs of locks commanded by a rotary Connection with eccentric ends; it has a multiple lock with key, with a sight hole with three situations as a function of each key turn; the main innovations details of the Rolling Chock in Tilting Bar lock (1) with the corresponding numbers on the seven drawn sheets are as the following: Tilting Bar (3); Rolling Wedge (4); C ounterpart (8 sheet 3); Slope Groove (9 sheet 3); Hinged Counterpart (10 sheet 3); Connection (12 sheet 7) with the locks; Multiple lock (13 sheet 6).

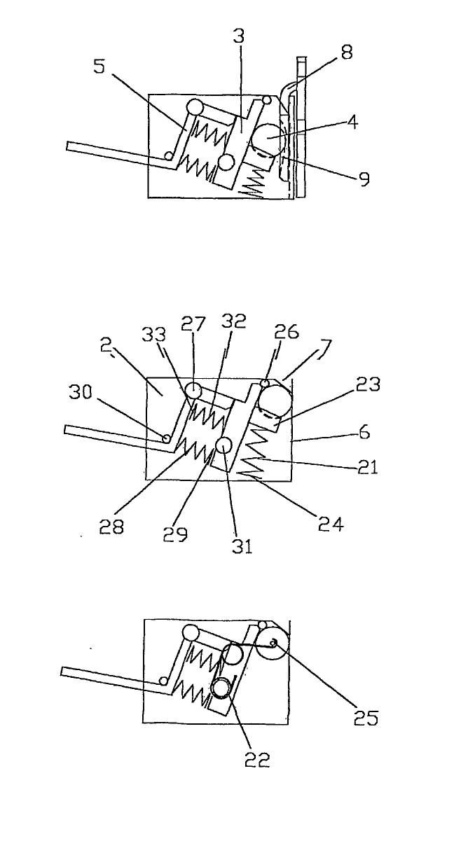

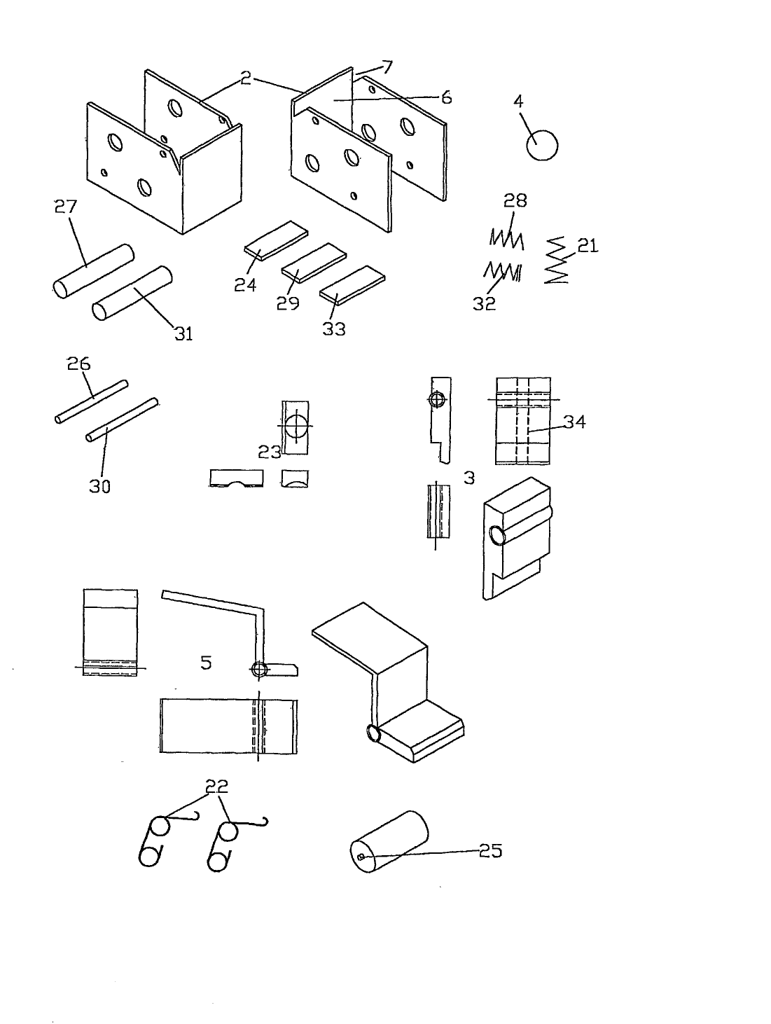

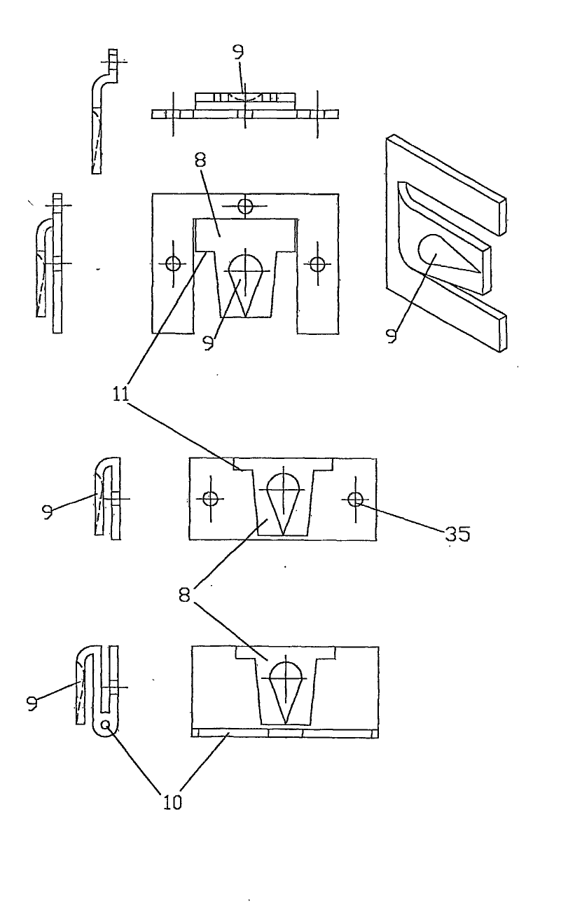

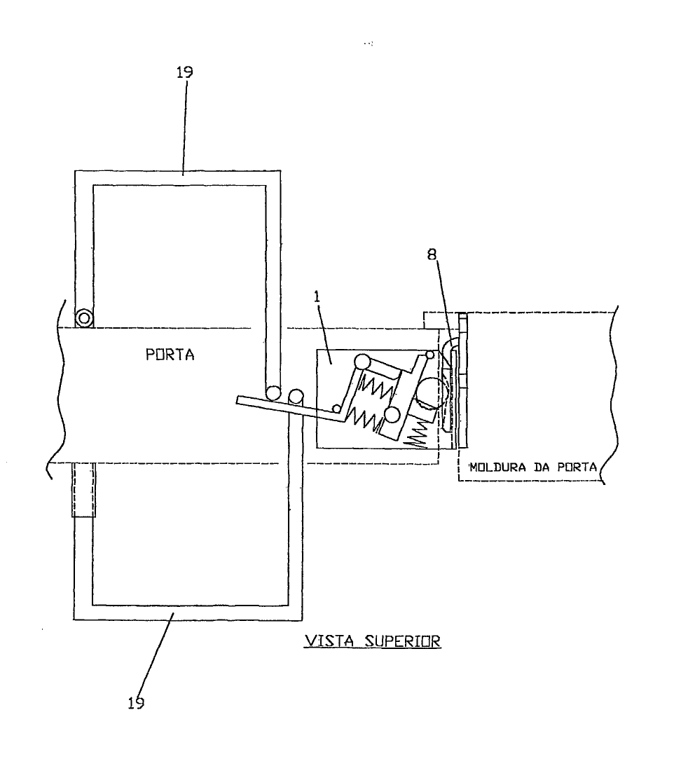

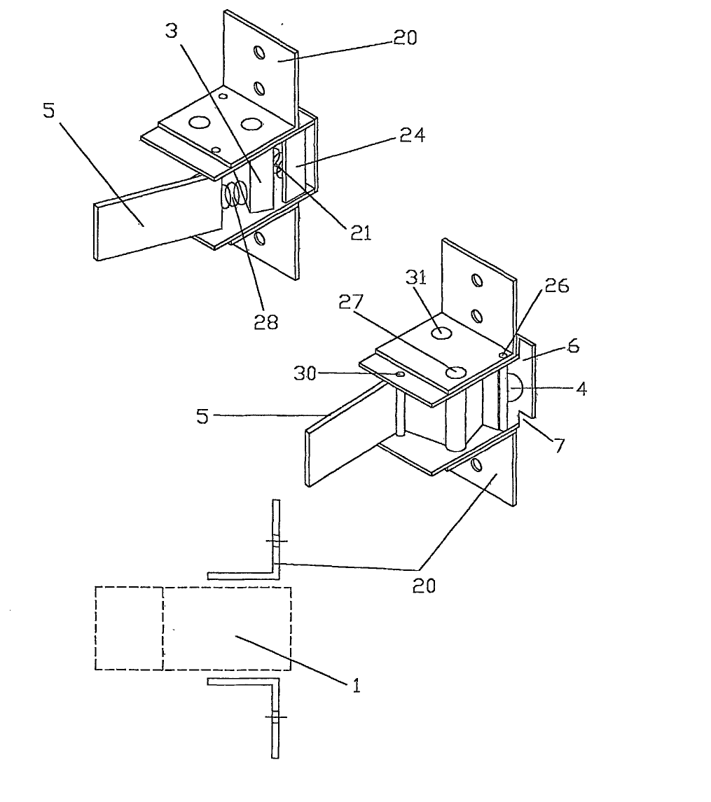

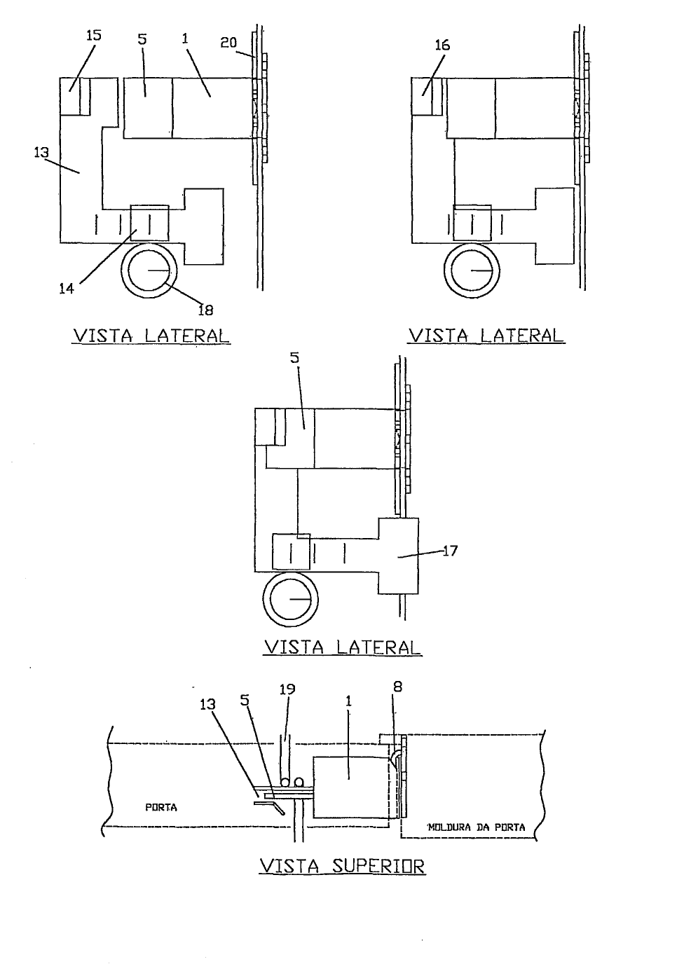

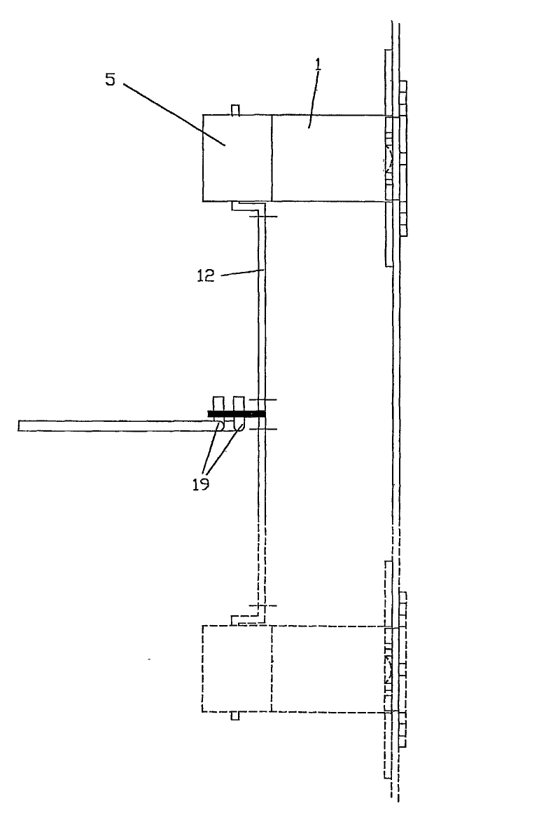

The Lock constitutes one and only invention, but, with all the details used in an innovative way.

The technical sector is that of Metallurgy.

The state of techniques: the traditional locks use door latch and catch that get out of the lock and penetrate in the doorframe, the manual door handle system is a rotary one, and they only work next to its own lock; the door latch and catch use their propriety of bending (folding).

Objectives of the invention: a low cost, safe, silent, versatile lock, which uses less movements and effort in less time in order to open and close; with a great simplicity of functioning and manufacturing, using in its main pieces the proprieties of extension of the materials that are far superior to those of the bending.

The technical effect, how it works and the novelty: a Counterpart (8) installed in the doorframe or in the rabbet of the door, which is connected to the lock in the same sense the door approaches, being fastened by the System of the Rolling Wedge (4) in the Tilting Bar (3), and integrating itself to a lock in any situation, forming only one block; the traditional catch is not needed with direct locking in the mechanism, but it is convenient that it is added as an optional extra security; it accepts any kind of door handle, but the most practical one that uses all the resources of the lock is the push-and-pull model (19), in any format, including the pushing side, the whole door can have the function of door handle; in closing the doors, as the closing system is continuous and as there is no impact whatsoever between the pieces of the lock and those installed in the doorframe, it is not necessary to lead the doors, that is, they can be closed just by giving them an impulse softly or violently; the proposed system possesses high resistance because the efforts made in the most exigent pieces are those of extension, presenting much more resistance than the one required for folding; the system can be used in any situation in which it is necessary to close, fasten or lock, from the portholes to big doors and gates, drawers, portable locks, discharge mechanisms, and in any other connection between two points, in which one part is in the situation of the Lock (1) and another in the situation of the Counterpart (8), including for the union of other objects; it uses as its basic pieces the Tilting Bar (3) with Rolling Wedge (4) locking the Counterpart (8) that is in the doorframe or in the rabbet of the door, which in turn has a Slope Groove (9); as the Counterpart (8) connecting itself to the lock, integrates itself to it forming only one block, this Counterpart can have hinges (10), which, together with locks installed in pairs enables the doors to be opened from the two sides (right and left); the Connection by Cable (12) which is eccentric or uses handle with rotary movement enables a doorhandle or a pair of doorhandles to command many locks and/or that one or more locks are added by commands situated in the different points of the door and by any part of the body of the person; the lock accepts the installation of any key mechanism already existing, including the simplest ones specially those for the closets, blocking the trigger, or as follows; the Multiple Lock (13) with the situation signalization (14) and key executing three situations, one with totally liberated lock (15), another one blocking the external doorhandle (16) and the third one blocking both doorhandles and all the trigger, in addition to locking with the catch in the traditional way (17); the Counterpart (8) penetrating into the lock, makes it between the Rolling Wedge (4) and the Trunk (6), but as there is not enough space, it pushes the referred Rolling Wedge (4) to a larger part due to the inclination of the Tilting Bar (3), and the result: the Counterpart (8) gets fastened between the Trunk (6) and the Rolling Wedge (4); the Counterpart (8) will only be free through the action of the Trigger (5) liberating the inclination of the Tilting Bar (3); the lock starts to lock before the door gets to its rabbet; the lock locks in a continuous and constant way starting from any of the following: with the Counterpart with Slope Groove (9), since the moment in which the Rolling Wedge (4) starts entering to its less deep part of the Slope until it is able to enter in the deepest part, as it get to the plenitude of locking (the first illustration of the first sheet of the design); with even Counterpart, since the moment in which the Rolling Wedge (4) will be over the cited Counterpart (8); the lock locks with small objects between the door and its rabbet; even though the movement of the door is not sufficient for total closing, but since the locking process has started with any vibration or movement of the door, the closing and locking will go forward in a continuous and constant form until it gets to the rabbet.

Identification of the details and pieces of the Designs in seven (7) sheet and thirty-five (35) items; until the number twenty (20) they are cited in the operation, and from the twenty-one (21) forward, they are basically auxiliary and construction items (in the sheets one and two there are the basic items of the lock, with variations and corn details of the pieces; in the sheet three there is the Counterpart, its details and variations; the sheet four shows the top view of the set; sheet five, the lock in 3D and its fastening; in the sheet six, the multiple lock; and sheet seven, the Connection by cable of the doorhandles with): (1) Lock by rolling Wedge in Tilting Bar; (2) Body (the body of the lock); (3) Tilting Bar: there must be an angle or inclination in relation to the Body, trunk and Counterpart from 09 to 25 degrees, in the system conjugated with the counterpart and its Groove; (4) Rolling Wedge: Sphere or roller of any format (spherical, oval, cylindrical and spool, always in total compatibility with the format of the Tilting Bar, the Trunk, and With the counterpart and its Groove); (5) Trigger to command the opening; (6) Trunk (integrating into the Body and where the posterior part of the Counterpart gets pressed); (7) Body Cut to improve the fastening of the Counterpart; (8 sheet 3) Counterpart to be fastened in the rabbet of the door; with Slope Groove the system locks with more efficiency; being even (without the Groove), it is simpler, for the lock not requiring lots of security; anyhow, in the inclinations of the Tilting Bar superior to 13 degrees, there should be compensation with the Groove in Ramp, but always on depending another; the segment of the Counterpart that penetrate in the locks can be of sheet, cylindrical, square or other intermediary forms in a way that there is always compatibility in the forms with the Trunk and the rolling Wedge; (9 sheet 3) Groove in Ramp: it makes the lock to lock in a more efficient and stable form and to compensate the angle superior to 13 degrees of the Tilting Bar up to maximum 25 degrees; it is ideal that the Slope Groove is always used, with any inclination of the Tilting Bar, but taking care of maintaining the equilibrium between the two; the angle of inclination of the Slope should always be close to that of the Tilting Bar, side by side, the Grooves in Slope can be flat (for the Cylindrical Rolling Wedges), in half-round (for Rolling Wedges of sphere or oval as in the designs of the sheet 3/7) or half-cylinder (spool), always depending of the format of the rolling Wedge; (10 sheet 3) Counterpart with hinge: as the counterpart integrates itself to the lock, there can be an option to install lock pairs on the two sides of the door, so that it opens from the both sides of the door; the hinge, too, compensates the parabolic movement of the door; (11 sheet 3) Parts that penetrates in the Body cut in order to improve, to establish the effect of the bar; (12 sheet 7) Cable Connection (steel wire) with eccentric ends or in handle with rotary movements that enable the doorhandle to be installed in a place and the lock in another, or with more than one lock, or still, that one or more locks can have commands from different points (13 sheet 6) Multiple lock system with situation signalization and key in three situations; situation one: totally liberated Lock; situation two: with one key turn blocking the external doorhandle and, situation three: with two key turns blocking both the doorhandles and all trigger and catch lockings in the traditional form; when there is a connection by Cable, the trigger blocking will be replaced by the referred Connection; (14 sheet 6) Status sighthole with a window signalizing the position of the catch; the signalization can be in the proper ratchet, or through arms and extensions from the preferential place of each one; (15 sheet 6) Lock closing without locking, without setting of the key and the catch (without key activating); (16 sheet 6) With one key turn and blocking the external doorhandle; (17 sheet 6) With two key turns, blocking both of the doorhandles, in addition to the trigger, and locking with a catch by the traditional system; (18 sheet 6) Key with cylinder; (19 sheet 4) Pull-and-Push Doorhandles in any format and with any system that enables pulling and pushing, including, from the side that the door is pushed, the whole door can have the function of lock; (20 sheet 5) Lock Fastening skirt (can be fastened in any part of the lock and in the necessary position); (21) Rolling Wedge Helicoid Spring; (22) Set of two lateral springs (another alternative for the Rolling Wedges); one spring on each side of the Tilting Bar and each one with two helicoids; (23) Rolling Wedge end guide; can be directly on the Rolling Wedge or in its shafts (if there is one); (24) Fastening Base of the Rolling Wedge Spring; (25) Shafts of the Rolling Wedge (a second option); (26) Limiter of the return of the Rolling Wedge and of the Tilting Bar; (27) Trigger shaft; (28) Trigger Spring; (29) Trigger Spring Base; (30) Trigger return Limiter; (31) Tilting Bar Shaft; (32) Tilting Bar Spring (33) Tilting Bar Spring Base; (34) A small groove for the Rolling Wedge (optional, also for the sphere); (35 sheet 3) Orifices for the fastening screws of rigid form or with stoppers, washers or flexible material filling.

The invention uses normal iron and steel; The iron for manufacturing of the most parts is in plates, with the exception of de Rolling Wedge (4), springs and Shafts should be of steel or some more resistant iron; for manufacturing in series of all the pieces that use iron sheet, only matrixes are necessary to be used in presses; the Tilting Bar (3) and the Trigger (5) can be done of sheet bended over themselves, but the best solution is the machine-made or forged iron; It is advisable that the Rolling Wedge (4) is acquired already industrialized mainly the spherical one which can be any sphere used in bearings; as the springs must be made of proper steel wires acquired in the market; as there is little friction between the pieces, softer materials can be used, since the piece that moves the most, the Rolling Wedge (4), as its name indicates, rolls on the Tilting Bar (3) and in the Counterpart (8); the lock doesn't require any welding, although due to the costs it may be used; the thickness of the iron or steel plate will depend on the size and on the use, but for the normal home lock the iron sheets from one to two millimeters can be used; the assembly is basically done putting each piece in its position, and simultaneously each corresponding pin, and, also the movement Limiters, the springs bases, and then to clinch, or to weld, or if it is an option, only match the ends of these pins, Limiters and springs bases, and for the last the springs; the fastening borders of the lock can be installed in the body of the lock in any position, through the proper pins, or those of the other pieces that are clinched or welded making the punctures to correspond.

1. ROLLING CHOCK IN TILTING BAR LOCK (1), characterized by a Rolling Wedge rolling over a Tilting Bar (3), locking the return of the Counterpart with Groove (8 and 9), installed in the Door frame (first design on the page one) and added with push-and-pull doorhandles, having the possibility to have hinges so that the door can be opened from both sides, having lock pairs commanded by Connection by rotary cable; it has multiple transversal locking bar by key, with situation sight hole, with three situations in the function of each key turn; the Rolling Chock in Tilting Bar Lock (1), whose patent by invention is being demanded, has following innovation details, with the respective numbers or pages of the designs: First Detail: Tilting Bar (3) with its spring (32) as a base of Rolling Wedge (4), with an angle or inclination in relation to Framework (2), to Trunk (6) and to Counterpart (8 sheet 3 of the design) from nine to twenty-five degrees, in a system conjugated with the Counterpart and its Groove (9 sheet 3); Second Detail: Rolling Wedge (4) by Sphere or roller of any format (spherical, oval, cylindrical, spool, with or without axle) always driven by springs (21, 22 and 23) and in total compatibility with the format of the Inclinable Bar (3), of the Trunk (6), and of the Counterpart (8) and its Groove (9 sheet 3); Third detail: Counterpart (8 sheet 3) to be fixed in the rabbet of the door; with Slope Groove (9) the lock system with more efficiency; being even (without Groove), is simpler, for locks that do not require much security; anyhow, in the inclinations of the Tilting Bar (3) superior to thirteen degrees, there must be a compensation with the Slope Groove (9), but always one depending another; the segments of the Counterpart (8) that penetrate in the locks can be made of lamina, cylindrical, square or other intermediary forms, so that there is always compatibility in the forms with the Trunk (6) and the Rolling Wedge (4); Fourth detail: Slope Groove (9) makes the lock to lock in the most efficient and stable way and to compensate the angle superior to thirteen degrees of the Inclinable (3) up to the maximum twenty-five degrees; It is ideal that Slope Groove (9) is always used, with any inclination of Tilting Bar (3), but, being careful in maintaining the equilibrium between the two; the angle of inclination of the Slope (9) must always be near that of the inclination of the Tilting Bar (3); side by side, The Slope Groove (9) can be flat (for the cylindrical Rolling Wedges), in half-round (for rolling Wedges of sphere or egg-shaped as the ones of the sheet 3) or half-cylinder (spool), always depending of the format of the Rolling Wedge; Fifth detail: Counterpart with hinge (10 sheet 3), as the Counterpart (8) integrates itself to the lock, There could be an option of installing lock pairs on the two sides of the door, so that it opens from both sides; the hinge also compensates the parabolic movement of the door; Sixth detail: Connection by cable (12 sheet 7) with eccentrical terminals or by a handle, with rotary movements that allow the doorhandles to be installed in one place and the lock in another place, or with more than one lock, or still, so that one ore more locks can be commanded from different points; Seventh detail: Multiple Lock (13 sheet 6) with situation signalization (14) and key in three situations: situation one (15) with totally liberated lock; situation two (16) with one turn of the key blocking the external doorhandle and, situation three (17) with two key turns blocking the two doorhandles and all the Trigger (5) and in addition, the catch locks the door in the traditional way; when there is a Connection by Cable (12), the Trigger blocking will be replaced by the blocking of the referred Connection; Eighth detail: Body (2), with the Trunk (6) and the Body Cut for a better fixing of the Counterpart (7); Ninth detail: the Trigger (5) with spring (28) and the push-and-pull doorhandles system (19 sheet 4) in any format and with any system that permits pull and push, being so that the pushing side the whole door can have the function of a doorhandle.
